(19) United States
(12) Patent Application Publication
(10) Pub. No.: US 2025/0377932 A1
(43) Pub. Date: Dec. 11, 2025

(54) METHOD AND SYSTEM FOR REINFORCED POLICY BASED WORKLOAD SCHEDULER

(71) Applicant: Dell Products L.P., Round Rock, TX (US)

(72) Inventors: Antony Prabakaran Jayaveeran, Singapore (SG); Raghavendra Puttappa, Singapore (SG); Kumaresan Pachiappan, Singapore (SG); Robin Kedia, Singapore (SG); Kah Wai Au, Singapore (SG)

(21) Appl. No.: 18/737,322

(22) Filed: Jun. 7, 2024

(51) Int. Cl. G06F 9/48

(52) U.S. Cl. CPC G06F 9/4881

(57) ABSTRACT

A method for managing a workload deployment includes: receiving a request; obtaining metadata and a policy associated with an edge node (EN); analyzing, against the policy, the request and the metadata to infer a current state (CS) of the EN; making, based on the analyzing, a determination that the CS of the EN is healthy and a workload associated with the request is suitable for the EN; and sending, based on the determination, a response to a scheduler to indicate that the scheduler is allowed to deploy the workload to the EN.

### BACKGROUND

Devices are often capable of performing certain functionalities that other devices are not configured to perform, or are not capable of performing. In such scenarios, it may be desirable to adapt one or more systems to enhance the functionalities of devices that cannot perform those functionalities.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example, and are not meant to limit the scope of the claims.

FIG. 1.1 shows a diagram of a system in accordance with one or more embodiments disclosed herein.

FIG. 1.2 shows a diagram of an edge node in accordance with one or more embodiments disclosed herein.

FIG. 1.3 shows a diagram of an infrastructure node in accordance with one or more embodiments disclosed herein.

FIG. 1.4 shows a diagram of an orchestrator in accordance with one or more embodiments disclosed herein.

FIGS. 2.1-2.3 show a method for managing a workload deployment to an edge node in accordance with one or more embodiments disclosed herein.

FIG. 3 shows a method for managing a policy executing on the edge node in accordance with one or more embodiments disclosed herein.

FIG. 4 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In the rapidly expanding technology domain of edge computing, computing devices (e.g., edge nodes, clients, Internet of Things (IoT) devices, etc.) vary significantly in their computational capabilities, network connectivity, and operational constraints. These computing devices often need to perform workloads/tasks or execute applications that align with their specific attributes (e.g., computing resources) and the policies governing them. To this end, a mere centralized scheduling method or a generic scheduling method may not suffice to manage these computing devices.

For at least the reasons discussed above and without requiring resource-intensive efforts (e.g., time, engineering, etc.), a fundamentally different approach/framework is needed (e.g., a framework that includes an advanced edge scheduler intricately designed to respond real-time device conditions of a corresponding edge device).

Embodiments disclosed herein relate to methods and systems for managing a workload deployment to an edge node. As a result of the processes discussed below, one or more embodiments disclosed herein advantageously ensure that: (i) the framework is not just a task manager; it is a symphony conductor, ensuring each component (e.g., hardware component, software component, etc.) of the framework plays its part accordingly (while adhering to device-specific policies defined by a user/administrator); (ii) by proactively identifying and addressing issues based on device states (e.g., Edge Node A is healthy, Edge Node G is unhealthy, etc.), unplanned device downtime is reduced and overall device reliability is improved; (iii) the framework can efficiently manage/handle many edge nodes (e.g., IoT devices), where the framework is suitable for scaling IoT deployments; (iv) device state data (e.g., metadata) associated with an edge node is collected and analyzed to obtain insights into the node's behavior, where the insights help a user (of the node) to make data-driven decisions (e.g., for a better user experience); (v) the framework provides efficient and reliable computing device (e.g., edge node) management; (vi) operational costs (related to an edge node) are reduced by ensuring that resource-intensive workloads/tasks (e.g., patch updates) are performed when computing resources of the edge node are available (e.g., not during peak usage time(s) of the resources) by defining one or more policies; (vii) by scheduling workloads based on policy-driven device states of an edge node, computing resource exhaustion is prevented, which leads to improved edge node performance and longevity; (viii) patch update downloads are performed when network bandwidth (BW) usage is below a pre-determined network usage threshold so that network congestion is prevented (for a better user experience); (ix) the framework (more specifically, the scheduler hosted by the framework) makes smart decisions at the edge node level, determining whether to execute a workload (on the corresponding edge node) based on real-time computing resource utilization on the edge node; (x) with the help of the framework (which is a decentralized approach), the need for centralized decision-making is minimized and more efficient computing resource allocation is enabled; and/or (xi) reward/feedback about policies (defined by a user by employing a machine learning (ML) model (e.g., a reinforcement learning model)) is used to refine the policies and to suggest the best policy that can be applied to edge nodes sharing the same node family.

The following describes various embodiments disclosed herein.

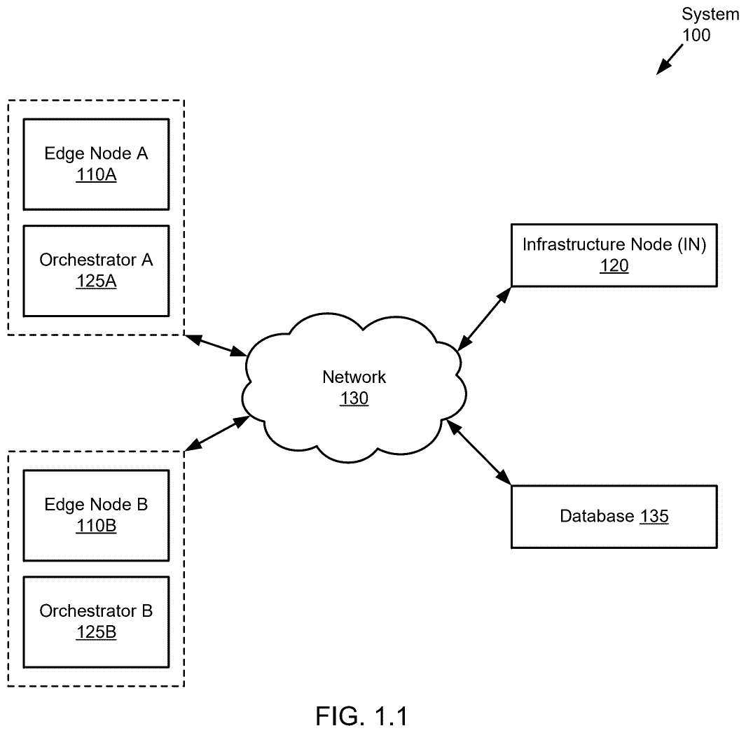

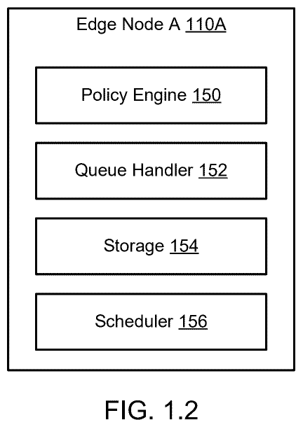

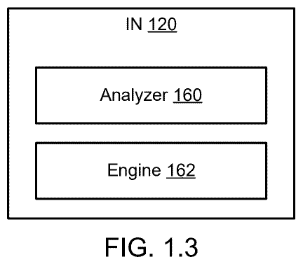

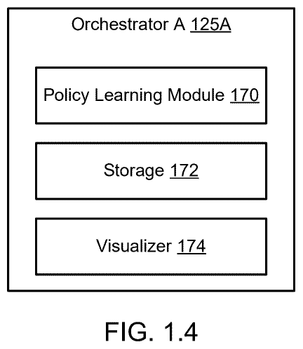

FIG. 1.1 shows a diagram of a system (100) in accordance with one or more embodiments disclosed herein. The system (100) includes any number of IoT devices or edge nodes (e.g., Edge Node A (110A), Edge Node B (110B), etc.), a network (130), any number of infrastructure nodes (IN) (e.g., 120), any number of orchestrators (e.g., Orchestrator A (125A), Orchestrator B (125B), etc.), and a database (135). The system (100) may include additional, fewer, and/or different components without departing from the scope of the embodiments disclosed herein. Each component may be operably/operatively connected to any of the other components via any combination of wired and/or wireless connections. Each component illustrated in FIG. 1.1 is discussed below.

In one or more embodiments, the edge nodes (e.g., 110A, 110B, etc.), the orchestrators (e.g., 125A, 125B, etc.), the IN (120), the network (130), and the database (135) may be (or may include) physical hardware or logical devices, as discussed below. While FIG. 1.1 shows a specific configuration of the system (100), other configurations may be used without departing from the scope of the embodiments disclosed herein. For example, although the edge nodes (e.g., 110A, 110B, etc.) and the IN (120) are shown to be operatively connected through a communication network (e.g., 130), the edge nodes (e.g., 110A, 110B, etc.) and the IN (120) may be directly connected (e.g., without an intervening communication network).

As yet another example, although the edge nodes (e.g., 110A, 110B, etc.) are considered as a first layer of the system (100), one or more edge servers (not shown) are considered as a second layer of the system (100), and the IN (120) is considered as a third layer of the system (100), the system (100) may include another layer (e.g., a fog layer) in between the second layer and third layer. The fog layer may include one or more “fog” devices, similar to that of edge servers, in which both the edge servers and fog devices perform distributed computing and focus on the physical deployment of compute and storage resources in relation to data that is being produced (e.g., the difference is a matter of where those resources are located such as edge computing refers to computational processes being done at or near the “edge” of an IoT environment (e.g., 100), whereas fog computing refers to the network connections between the edge servers and a cloud (or a cloud environment) (e.g., 120) to extend the cloud closer to the edge of the IoT environment).

As yet another example, in one embodiment, a functional edge region (where the actual functioning happens such as, for example, a user uses an edge node (e.g., a client) to make a product or to deliver a service), a far edge region (including, at least, compute, storage, and/or network access devices focused on data acquisition and processing), and a near edge region of the system (100) may be co-located in one site/factory, and, in another embodiment, the functional edge and far edge regions may be co-located in one site and the near edge region may represent a cloud environment (or a cloud computing environment). In this example, the near edge region may be far away from the functional edge and far edge regions where the near edge region may represent a centralized and geographically distant cloud environment (e.g., an environment that is hundreds of miles away from the site).

Further, the functioning of the edge nodes (e.g., 110A, 110B, etc.), the orchestrators (e.g., 125A, 125B, etc.), and the IN (120) is not dependent upon the functioning and/or existence of the other components (e.g., devices) in the system (100). Rather, the edge nodes, the orchestrators, and the IN may function independently and perform operations locally that do not require communication with other components. Accordingly, embodiments disclosed herein should not be limited to the configuration of components shown in FIG. 1.1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

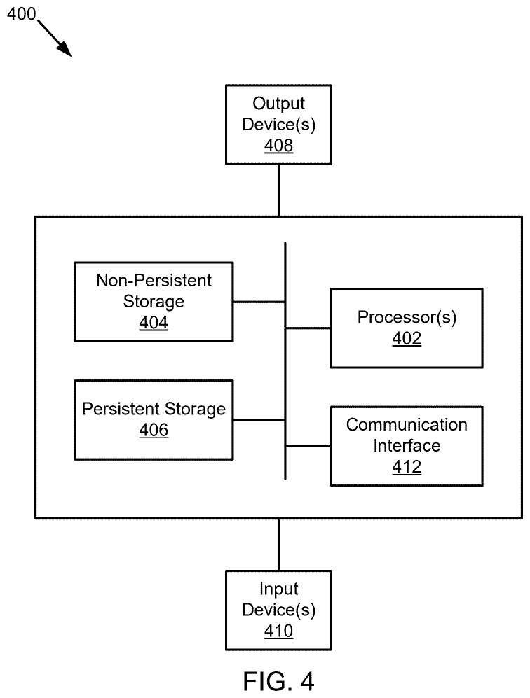

In one or more embodiments, the system (100) may be a distributed system (e.g., a data processing environment) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of clients (e.g., the edge nodes (e.g., 110A, 110B, etc.)). For example, the system may be configured to organize unbounded, continuously generated data into a data stream. The system (100) may also represent a comprehensive middleware layer executing on computing devices (e.g., 400, FIG. 4) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users' site using the edge nodes (e.g., 110A, 110B, etc.)) and other computations remotely (e.g., away from the users' site using the IN (120)) from the users. By doing so, the users may utilize different computing devices (e.g., 400, FIG. 4) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of an edge node (described below). The resource may be delivered to the edge node via, for example (but not limited to): conventional installation, a method for streaming, a VM executing on a remote computing device, execution from a removable storage device connected to the edge node (such as universal serial bus (USB) device), etc.

In one or more embodiments, an edge node (e.g., 110A, 110B, etc.) may include functionality to, e.g.,: (i) capture sensory input (e.g., sensor data) in the form of text, audio, video, touch or motion, (ii) collect massive amounts of data at the edge of an IoT network (where, the collected data may be grouped as: (a) data that needs no further action and does not need to be stored, (b) data that should be retained for later analysis and/or record keeping, and (c) data that requires an immediate action/response), (iii) provide to other entities (e.g., the edge servers, the IN (120), etc.), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the edge node may perform other functionalities without departing from the scope of the embodiments disclosed herein.

In one or more embodiments, the edge nodes (e.g., 110A, 110B, etc.) may be geographically distributed devices (e.g., user devices, front-end devices, etc.) and may have relatively restricted hardware and/or software resources when compared to the IN (120). As being, for example, a sensing device, each of the edge nodes may be adapted to provide monitoring services. For example, an edge node may monitor the state of a scene (e.g., objects disposed in a scene). The monitoring may be performed by obtaining sensor data from sensors that are adapted to obtain information regarding the scene, in which an edge node may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the edge nodes (e.g., 110A, 110B, etc.) may be physical or logical computing devices configured for hosting one or more workloads, or for providing a computing environment whereon workloads may be implemented. The edge nodes may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the edge nodes). The edge nodes (e.g., 110A, 110B, etc.) may correspond to computing devices that one or more users use to interact with one or more components of the system (100).

In one or more embodiments, an edge node (e.g., 110A, 110B, etc.) may include any number of applications (and/or content accessible through the applications) that provide computer-implemented services to a user. Applications may be designed and configured to perform one or more functions instantiated by a user of the edge node. In order to provide application services, each application may host similar or different components. The components may be, for example (but not limited to): instances of databases, instances of email servers, etc. Applications may be executed on one or more edge nodes as instances of the application.

Applications may vary in different embodiments, but in certain embodiments, applications may be custom developed or commercial (e.g., off-the-shelf) applications that a user desires to execute in an edge node (e.g., 110A, 110B, etc.). In one or more embodiments, applications may be logical entities executed using computing resources of an edge node. For example, applications may be implemented as computer instructions stored on persistent storage of the edge node that when executed by the processor(s) of the edge node, cause the edge node to provide the functionality of the applications described throughout the application.

In one or more embodiments, while performing, for example, one or more operations requested by a user, applications installed on an edge node (e.g., 110A, 110B, etc.) may include functionality to request and use physical and logical resources of the edge node. Applications may also include functionality to use data stored in storage/memory resources of the edge node. The applications may perform other types of functionalities not listed above without departing from the scope of the embodiments disclosed herein. While providing application services to a user, applications may store data that may be relevant to the user in storage/memory resources of the edge node.

In one or more embodiments, to provide services to the users, the edge nodes (e.g., 110A, 110B, etc.) may utilize, rely on, or otherwise cooperate with the IN (120). For example, the edge nodes may issue requests to the IN to receive responses and interact with various components of the IN. The edge nodes may also request data from and/or send data to the IN (for example, the edge nodes may transmit information to the IN that allows the IN to perform computations, the results of which are used by the edge nodes to provide services to the users). As yet another example, the edge nodes may utilize computer-implemented services provided by the IN. When the edge nodes interact with the IN, data that is relevant to the edge nodes may be stored (temporarily or permanently) in the IN.

In one or more embodiments, an edge node (e.g., 110A, 110B, etc.) may be capable of, e.g.,: (i) collecting users' inputs, (ii) correlating collected users' inputs to the computer-implemented services to be provided to the users, (iii) communicating with the IN (120) that perform computations necessary to provide the computer-implemented services, (iv) using the computations performed by the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the edge nodes (e.g., 110A, 110B, etc.) may provide computer-implemented services to users (and/or other computing devices). The edge nodes may provide any number and any type of computer-implemented services. To provide computer-implemented services, each edge node may include a collection of physical components (e.g., processing resources, storage/memory resources, networking resources, etc.) configured to perform operations of the edge node and/or otherwise execute a collection of logical components (e.g., virtualization resources) of the edge node.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the edge nodes (e.g., 110A, 110B, etc.) provide computer-implemented services to users, the edge nodes may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the edge nodes (e.g., 110A, 110B, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface an edge node with external entities (e.g., the IN (120)) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the edge node and the external entities. For example, a networking resource may enable the edge node to be operatively connected, via Ethernet, using a TCP protocol to form a “network fabric”, and may enable the communication of data between the edge node and the external entities. In one or more embodiments, each edge node may be given a unique identifier (e.g., an Internet Protocol (IP) address) to be used when utilizing the above-mentioned protocols.

Further, a networking resource, when using a certain protocol or a variant thereof, may support streamlined access to storage/memory media of other edge nodes (e.g., 110A, 110B, etc.). For example, when utilizing remote direct memory access (RDMA) to access data on another edge node, it may not be necessary to interact with the logical components of that edge node. Rather, when using RDMA, it may be possible for the networking resource to interact with the physical components of that edge node to retrieve and/or transmit data, thereby avoiding any higher-level processing by the logical components executing on that edge node.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of an edge node (e.g., 110A, 110B, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the edge node that when executed by processing resources of the edge node, cause the edge node to provide the functionality of the hypervisor.

Additional details of an edge node are described below in reference to FIG. 1.2.

In one or more embodiments, an edge node (e.g., 110A, 110B, etc.) may be, for example (but not limited to): a physical computing device, a smartphone, a tablet, a wearable, a gadget, a closed-circuit television (CCTV) camera, a music player, a game controller, etc. Different edge nodes may have different computational capabilities. In one or more embodiments, Edge Node A (110A) may have 16 gigabytes (GB) of dynamic RAM (DRAM) and 1 CPU with 12 cores, whereas Edge Node B (110B) may have 8 GB of PMEM and 1 CPU with 16 cores. Other different computational capabilities of the edge nodes not listed above may also be taken into account without departing from the scope of the embodiments disclosed herein.

Further, in one or more embodiments, an edge node (e.g., 110A, 110B, etc.) may be implemented as a computing device (e.g., 400, FIG. 4). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the edge node described throughout the application.

Alternatively, in one or more embodiments, the edge node (e.g., 110A, 110B, etc.) may be implemented as a logical device (e.g., a VM). The logical device may utilize the computing resources of any number of computing devices to provide the functionality of the edge node described throughout this application.

In one or more embodiments, users (e.g., customers, administrators, people, etc.) may interact with (or operate) the edge nodes (e.g., 110A, 110B, etc.) in order to perform work-related tasks (e.g., production workloads). In one or more embodiments, the accessibility of users to the edge nodes may depend on a regulation set by an administrator of the edge nodes. To this end, each user may have a personalized user account that may, for example, grant access to certain data, applications, and computing resources of the edge nodes. This may be realized by implementing the virtualization technology. In one or more embodiments, an administrator may be a user with permission (e.g., a user that has root-level access) to make changes on the edge nodes that will affect other users of the edge nodes.

In one or more embodiments, for example, a user may be automatically directed to a login screen of an edge node when the user connected to that edge node. Once the login screen of the edge node is displayed, the user may enter credentials (e.g., username, password, etc.) of the user on the login screen. The login screen may be a graphical user interface (GUI) generated by a visualization module (not shown) of the edge node. In one or more embodiments, the visualization module may be implemented in hardware (e.g., any number of integrated circuits for processing computer readable instructions), software, or any combination thereof.

In one or more embodiments, a GUI may be displayed on a display of a computing device (e.g., 400, FIG. 4) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, through the concept of edge computing, some of the computational load may be moved towards to the edge of the network to harness computational capabilities (of the edge servers) that may be untapped, which are located closer (for example, one-hop away from an edge node (e.g., 110A, 110B, etc.)) to users to reduce possible network latency (for example, for mission critical and/or latency-sensitive applications).

In one or more embodiments, to be able to communicate with the IN (120) (e.g., an IoT hub), an edge node (e.g., 110A, 110B, etc.) and/or an edge server may register to the IoT hub. For example, to be able to register/connect to the IoT hub, an edge node may make an application programming interface (API) call to the IoT hub. Based on receiving an API call from the edge node, the IoT hub may send a connection string (which has a predetermined length) to the edge node. The edge node may then use the connection string to connect to the IoT hub.

In one or more embodiments, an edge server may be, for example (but not limited to): a physical computing device, a router, a switch, a network device with routing or switching functionality, a small/macro base station, a small enclosure (with several servers and some storage) installed atop of a wind turbine to collect and process data, etc.

In one or more embodiments, one or more edge servers may be geographically distributed so that computing may be performed closer to the source of data (e.g., edge nodes (e.g., 110A, 110B, etc.) where data is generated) to improve a service that is delivered to a user of an edge node. In one or more embodiments, an edge server (via its collector (not shown)) may monitor operational states of the edge nodes (e.g., 110A, 110B, etc.). The operational state of an edge node may correspond to the ability of the edge node to perform predetermined functionalities (e.g., obtaining information regarding a scene associated with an edge node).

In one or more embodiments, the connection string may be a data structure that includes one or more parameters (e.g., location information of the IN (120), authentication information associated with the IN (120), etc.) required for an entity to connect to the IoT hub (or any component). In one or more embodiments, the corresponding component of the IoT hub may be offline for, for example, a system maintenance to configure and upgrade an operating system (OS). While the corresponding component is offline, the connection between an edge node (e.g., 110A, 110B, etc.) and the corresponding component may be disconnected. When the corresponding component comes back online, the edge node may reconnect to the corresponding component using the same connection string.

In one or more embodiments, the IN (120) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, the IN (120) may include functionality to, e.g.,: (i) obtain (or receive) data (e.g., any type and/or quantity of input) from any source (and, if necessary, aggregate the data); (ii) perform complex analytics and analyze data that is received from one or more edge nodes (e.g., 110A, 110B, etc.) to generate additional data that is derived from the obtained data without experiencing any middleware and hardware limitations; (iii) provide meaningful information (e.g., a response) back to the corresponding edge nodes; (iv) filter data (e.g., received from an edge node) before pushing the data (and/or the derived data) to the database (135) for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or ML models to perform cloud-based data processing); (vii) incorporate strategies (e.g., strategies to provide VDI capabilities) for remotely enhancing capabilities of the edge nodes; (viii) provide robust security features to the edge nodes and make sure that a minimum level of service is always provided to a user of an edge node; (ix) transmit the result(s) of the computing work performed (e.g., real-time business insights, equipment maintenance predictions, other actionable responses, etc.) to another IN (not shown) for review and/or other human interactions; (x) exchange data with other devices registered in/to the network (130) in order to, for example, participate in a collaborative workload placement (e.g., the IN may split up a request (e.g., an operation, a task, an activity, etc.) with another IN, coordinating its efforts to complete the request more efficiently than if the IN had been responsible for completing the request); (xi) provide software-defined data protection for the edge nodes (e.g., 110A, 110B, etc.); (xii) provide automated data discovery, protection, management, and recovery operations for the edge nodes; (xiii) monitor operational states of the edge nodes; (xiv) regularly back up configuration information of the edge nodes to the database (135); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the edge nodes and/or database; (xvii) provide data deduplication; (xviii) orchestrate data protection through one or more GUIs; (xix) empower data owners (e.g., users of the edge nodes) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, edge nodes) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxV) manage operations of one or more edge nodes (e.g., receiving information from the edge nodes regarding changes in the operation of the edge nodes) to improve their operations (e.g., improve the quality of data being generated, decrease the computing resources cost of generating data, etc.). In one or more embodiments, in order to read, write, or store data, the IN (120) may communicate with, for example, the database (135) and/or other storage devices in the system (100).

As described above, the IN (120) may be capable of providing a range of functionalities/services to the users of the edge nodes (e.g., 110A, 110B, etc.). However, not all of the users may be allowed to receive all of the services. To manage the services provided to the users of the edge nodes, a system (e.g., a service manager) in accordance with embodiments disclosed herein may manage the operation of a network (e.g., 130), in which the edge nodes are operably connected to the IN. Specifically, the service manager (i) may identify services to be provided by the IN (for example, based on the number of users using the edge nodes) and (ii) may limit communications of the edge nodes to receive IN provided services.

For example, the priority (e.g., the user access level) of a user may be used to determine how to manage computing resources of the IN (120) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IN (120) (e.g., while the computing resources of the IN may be capable of providing/performing any number of remote computer-implemented services, they may be limited in providing some of the services over the network (130)) and (ii) network traffic from that user is to be afforded a normal level of quality (e.g., a normal processing rate with a limited communication (BW)). By doing so, (i) computer-implemented services provided to the users of the edge nodes (e.g., 110A, 110B, etc.) may be granularly configured without modifying the operation(s) of the edge nodes and (ii) the overhead for managing the services of the edge nodes may be reduced by not requiring modification of the operation(s) of the edge nodes directly.

In contrast, a second user may be determined to be a high priority user (e.g., a privileged user, a user with a user access level of 9/10). In such a case, the user level of that user may indicate that more ports are to be opened than were for the first user so that (i) the IN (120) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, OS data, etc.), medium workloads with higher priority (e.g., VM with FS data, network data management protocol (NDMP) data, etc.), large workloads with critical priority (e.g., mission critical application data), etc.

Further, while a single IN (e.g., 120) is considered above, the term “node” includes any collection of systems or sub-systems that individually or jointly execute a set, or multiple sets, of instructions to provide one or more computer-implemented services. For example, a single IN may provide a computer-implemented service on its own (i.e., independently) while multiple other nodes may provide a second computer-implemented service cooperatively (e.g., each of the multiple other nodes may provide similar and or different services that form the cooperatively provided service).

As described above, the IN (120) may provide any quantity and any type of computer-implemented services. To provide computer-implemented services, the IN may be a heterogeneous set, including a collection of physical components/resources (discussed above) configured to perform operations of the IN and/or otherwise execute a collection of logical components/resources (discussed above) of the IN.

In one or more embodiments, the IN (120) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

One of ordinary skill will appreciate that the IN (120) may perform other functionalities without departing from the scope of the embodiments disclosed herein.

In one or more embodiments, the IN (120) may be implemented as a computing device (e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to an edge node (e.g., 110A, 110B, etc.), the IN (120) may also be implemented as a logical device.

In one or more embodiments, the IN (120) may host an analyzer (e.g., 160, FIG. 1.3) and an engine (e.g., 162, FIG. 1.3). Additional details of the analyzer and engine are described below in reference to FIG. 1.3. In the embodiments of the present disclosure, the database (135) is demonstrated as a separate entity from the IN (120); however, embodiments disclosed herein are not limited as such. The database (135) may be demonstrated as a part of the IN (e.g., as deployed to the IN).

Referring to FIG. 1.1, in one embodiment, each orchestrator (e.g., 125A) may manage (or communicate with) a single edge node (e.g., 110A) (said another way, each edge node may have its own orchestrator). In another embodiment, a single orchestrator (e.g., 125B) may manage (or communicate with) one or more edge nodes (e.g., a cluster of edge nodes). Those skilled in the art will appreciate that other types of relationships may exist between edge nodes and orchestrators without departing from the scope of the embodiments disclosed herein.

In one or more embodiments, an orchestrator (e.g., 125A, 125B, etc.) may host a policy learning module (e.g., 170, FIG. 1.4), storage (e.g., 172, FIG. 1.4), and a visualizer (e.g., 174, FIG. 1.4). Additional details of the orchestrator are described below in reference to FIG. 1.4.

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the edge nodes, the IN, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the edge nodes and the IN through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VOIP), etc.

Turning now to the database (135), the database (135) may provide long-term, durable, high read/write throughput data storage/protection with near-infinite scale and low-cost. The database (135) may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. Further, the database (135) may also occupy a portion of a physical storage/memory device or, alternatively, may span across multiple physical storage/memory devices.

In one or more embodiments, the database (135) may be implemented using physical devices that provide data storage services (e.g., storing data and providing copies of previously stored data). The devices that provide data storage services may include hardware devices and/or logical devices. For example, the database (135) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (135) may include a memory device (e.g., a dual in-line memory device), in which data is stored and from which copies of previously stored data are provided. As yet another example, the database (135) may include a persistent storage device (e.g., an SSD), in which data is stored and from which copies of previously stored data is provided. As yet another example, the database (135) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database (135) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the database (135) may store/record unstructured and/or structured data that may include (or specify), for example (but not limited to): an identifier of a user/customer (e.g., a unique string or combination of bits associated with a particular user); a request received from a user (or a user's account); a geographic location (e.g., a country) associated with the user; a timestamp showing when a specific request is processed by an application; a port number (e.g., associated with a hardware component of an edge node (e.g., 110A)); a protocol type associated with a port number; computing resource details (including details of hardware components and/or software components) and an IP address of an IN (e.g., 120) hosting an application where a specific request is processed; an identifier of an application; information with respect to historical metadata (e.g., system logs, applications logs, telemetry data including past and present device usage of one or more computing devices in the system (100), etc.); computing resource details and an IP address of an edge node that sent a specific request (e.g., to the IN (120)); one or more points-in-time and/or one or more periods of time associated with a data recovery event; data for execution of applications/services (including IN applications and associated end-points); corpuses of annotated data used to build/generate and train processing classifiers for trained ML models; linear, non-linear, and/or ML model parameters (e.g., instructions to the engine (e.g., 162, FIG. 1.3) on how to train and/or fine-tune a model); an identifier of a sensor; a product identifier of an edge node (e.g., 110A); a type of an edge node; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; a distributed model identifier that uniquely identifies a distributed model; a user activity performed on a data item; a cumulative history of user/administrator activity records obtained over a prolonged period of time; a setting (and a version) of a mission critical application executing on an IN (e.g., 120); an SLA/SLO set by a user; a data protection policy (e.g., an affinity-based backup policy) implemented by a user (e.g., to protect a local data center, to perform a rapid recovery, etc.); a configuration setting of that policy; product configuration information associated with an edge node; a number of each type of a set of assets protected by an IN (e.g., 120); a size of each of the set of assets protected; a number of each type of a set of data protection policies implemented by a user; configuration information associated with the analyzer (e.g., 160, FIG. 1.3) (to manage security, network traffic, network access, or any other function/operation performed by the analyzer); configuration information associated with the engine (e.g., 162, FIG. 1.3) (to manage security, network traffic, network access, or any other function/operation performed by the engine); information associated with a hardware resource set (discussed below) of the IN (120); a number of requests handled (in parallel) per minute (or per second, per hour, etc.) by the analyzer; a documentation that shows how the analyzer performs against an SLO and/or an SLA; a workflow (e.g., a policy that dictates how a workload should be configured and/or protected, such as a structured query language (SQL) workflow dictates how an SQL workload should be protected) set (by a user); a type of a workload that is tested/validated by an administrator per data protection policy; a practice recommended by a vendor (e.g., a single data protection policy should not protect more than 100 assets; for a dynamic NAS, maximum one billion files can be protected per day, etc.); one or more device state paths corresponding to a device (e.g., an edge node); an existing knowledge base (KB) article; a technical support history documentation of a customer/user; a port's user guide; a port's release note; a community forum question and its associated answer; a catalog file of an application upgrade; details of a compatible OS version for an application upgrade to be installed; an application upgrade sequence; a solution or a workaround document for a software failure; one or more lists that specify which computer-implemented services should be provided to which user (depending on a user access level of a user); a fraud report for an invalid user; a set of SLAs (e.g., an agreement that indicates a period of time required to retain a profile of a user); information with respect to a user/customer experience; one or more user-defined policies executing on an edge node; etc.

In one or more embodiments, information associated with a hardware resource set (e.g., including at least resource related parameters) may specify, for example (but not limited to): a configurable CPU option (e.g., a valid/legitimate vCPU count per IN in the system (100)), a configurable network resource option (e.g., enabling/disabling single-root input/output virtualization (SR-IOV) for the IN (120)), a configurable memory option (e.g., maximum and minimum memory per IN in the system (100)), a configurable GPU option (e.g., allowable scheduling policy and/or virtual GPU (vGPU) count combinations per IN in the system (100)), a configurable DPU option (e.g., legitimacy of disabling inter-integrated circuit (I2C) for various INs in the system (100)), a configurable storage space option (e.g., a list of disk cloning technologies across one or more INs in the system (100)), a configurable storage input/output (I/O) option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QOS) template), a DPU related template (e.g., a 1 GB/s BW vDPU with 1 GB vDPU frame buffer template), a GPU related template (e.g., a depth-first vGPU with 1 GB vGPU frame buffer template), a storage space related template (e.g., a 40 GB SSD storage template), a CPU related template (e.g., a 1 vCPU with 4 cores template), a memory resource related template (e.g., an 8 GB DRAM template), a vCPU count per analytics engine, a virtual NIC (vNIC) count per IN in the system (100), a wake on LAN support configuration (e.g., supported/enabled, not supported/disabled, etc.), a vGPU count per IN in the system (100), a type of a vGPU scheduling policy (e.g., a “fixed share” vGPU scheduling policy), a storage mode configuration (e.g., an enabled high-performance storage array mode), etc.

In one or more embodiments, as being telemetry data, a system log (e.g., a file that records system activities across hardware and/or software components of an edge node, an internal lifecycle controller log (which may be generated as a result of internal testing of a NIC), etc.) may include (or specify), for example (but not limited to): a type of an asset (e.g., a type of a workload such as an SQL database, a NAS executing on-premises, a VM executing on a multi-cloud infrastructure, etc.) that is utilized by a user; computing resource utilization data (or key performance metrics including estimates, measurements, etc.) (e.g., data related to a user's maximum, minimum, and average CPU utilizations, an amount of storage or memory resource utilized by a user, an amount of networking resource utilized by user to perform a network operation, etc.) regarding computing resources of an edge node (e.g., 110A); an alert that is triggered in an edge node (e.g., based on a failed cloud disaster recovery operation (which is initiated by a user), the edge node may generate a failure alert); an important keyword associated with a hardware component of an edge node (e.g., recommended maximum CPU operating temperature is 75° C.); a computing functionality of a microservice (e.g., Microservice A's CPU utilization is 26%, Microservice B's GPU utilization is 38%, etc.); an amount of storage or memory resource (e.g., stack memory, heap memory, cache memory, etc.) utilized by a microservice (e.g., executing on an edge node); a certain file operation performed by a microservice; an amount of networking resource utilized by a microservice to perform a network operation (e.g., to publish and coordinate inter-process communications); an amount of bare metal communications executed by a microservice (e.g., I/O operations executed by the microservice per second); a quantity of threads (e.g., a term indicating the quantity of operations that may be handled by a processor at once) utilized by a process that is executed by a microservice; an identifier of an edge node's manufacturer; media access control (MAC) information of an edge node; an amount of bare metal communication executed by an edge node (e.g., I/O operations executed by an edge node per second); etc.

In one or more embodiments, an alert (e.g., a predictive alert, a proactive alert, a technical alert, etc.) may be defined by a vendor of a corresponding edge node (e.g., 110A), by an administrator, by another entity, or any combination thereof. In one or more embodiments, an alert may specify, for example (but not limited to): a medium-level of CPU overheating is detected, a recommended maximum CPU operating temperature is exceeded, etc. Further, an alert may be defined based on a data protection policy.

In one or more embodiments, an important keyword may be defined by a vendor of a corresponding edge node (e.g., 110A), by a technical support specialist, by the administrator, by another entity, or any combination thereof. In one or more embodiments, an important keyword may be a specific technical term or a vendor specific term that is used in a system log.

In one or more embodiments, as being telemetry data, an application log may include (or specify), for example (but not limited to): a type of a file system (e.g., a new technology file system (NTFS), a resilient file system (ReFS), etc.); a product identifier of an application; a version of an OS that an application is executing on; a display resolution configuration of an edge node; a health status of an application (e.g., healthy, unhealthy, etc.); warnings and/or errors reported for an application; a language setting of an OS; a setting of an application (e.g., a current setting that is being applied to an application either by a user or by default, in which the setting may be a font option that is selected by the user, a background setting of the application, etc.); a version of an application; a warning reported for an application (e.g., unknown software exception (0xc00d) occurred in the application at location 0x0007d); a type of an OS (e.g., a workstation OS); an amount of storage used by an application; a size of an application (size (e.g., 5 Megabytes (5 MB), 5 GB, etc.) of an application may specify how much storage space is being consumed by that application); a type of an application (a type of an application may specify that, for example, the application is a support, deployment, or recycling application); a priority of an application (e.g., a priority class of an application, described below); active and inactive session counts; etc.

As used herein, “unhealthy” may refer to a compromised health state (e.g., an unhealthy state), indicating a corresponding entity (e.g., a hardware component, an edge node, an application, etc.) has already or is likely to, in the future, be no longer able to provide the services that the entity has previously provided. The health state determination may be made via any method based on the aggregated health information without departing from the scope of the embodiments disclosed herein.

In one or more embodiments, a priority class may be based on, for example (but not limited to): an application's tolerance for downtime, a size of an application, a relationship (e.g., a dependency) of an application to other applications, etc. Applications may be classified based on each application's tolerance for downtime. For example, based on the classification, an application may be assigned to one of three classes such as Class I, Class II, and Class III. A “Class I” application may be an application that cannot tolerate downtime. A “Class II” application may be an application that can tolerate a period of downtime (e.g., an hour or other period of time determined by an administrator or a user). A “Class III” application may be an application that can tolerate any amount of downtime.

In one or more embodiments, metadata (e.g., system logs, application logs, etc.) may be obtained (or dynamically fetched) as they become available (e.g., with no user manual intervention), or by the analyzer (e.g., 160, FIG. 1.3) polling a corresponding edge node (e.g., 110A) (by making schedule-driven/periodic API calls to the edge node without affecting the edge node's ongoing production workloads) for newer metadata. Based on receiving the API calls from the analyzer, the edge node may allow the analyzer to obtain the metadata.

In one or more embodiments, the metadata may be obtained (or streamed) continuously as they generated, or they may be obtained in batches, for example, in scenarios where (i) the analyzer (e.g., 160, FIG. 1.3) receives a metadata analysis request (or a health check request for an edge node), (ii) another IN of the system (100) accumulates the metadata and provides them to the analyzer at fixed time intervals, or (iii) the database (135) stores the metadata and notify the analyzer to access the metadata from the database. In one or more embodiments, metadata may be access-protected for a transmission from a corresponding edge node (e.g., 110A) to the analyzer (e.g., 160, FIG. 1.3), e.g., using encryption.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored in the database (135), any of the aforementioned data structures may be stored in different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) (provided by vendors) and/or by the administrators based on, for example, newer (e.g., updated) versions of external information. The unstructured and/or structured data may also be updated when, for example (but not limited to): newer system logs are received, a state of the analyzer (e.g., 160, FIG. 1.3) is changed, etc.

While the database (135) has been illustrated and described as including a limited number and type of data, the database (135) may store additional, less, and/or different data without departing from the scope of the embodiments disclosed herein. One of ordinary skill will appreciate that the database (135) may perform other functionalities without departing from the scope of the embodiments disclosed herein.

While FIG. 1.1 shows a configuration of components, other system configurations may be used without departing from the scope of the embodiments disclosed herein.

Turning now to FIG. 1.2, FIG. 1.2 shows a diagram of an edge node (e.g., Edge Node A (110A)) in accordance with one or more embodiments disclosed herein. Edge Node A (110A) includes a policy engine (150), a queue handler (152), storage (154), and a scheduler (156). Edge Node A (110A) may include additional, fewer, and/or different components without departing from the scope of the embodiments disclosed herein. Each component may be operably connected to any of the other component via any combination of wired and/or wireless connections. Each component illustrated in FIG. 1.2 is discussed below.

In one or more embodiments, the policy engine (150) may include functionality to, e.g.,: (i) receive/obtain a workload deployment request from the scheduler (156); (ii) in response to receiving the request, obtain metadata (e.g., application logs, system logs, etc.) and a set of policies associated with Edge Node A (110A); (iii) against the set of policies (e.g., baseline policies), and by employing a linear model, a non-linear model, and/or an ML model, analyze (a) the metadata to infer Edge Node A's health state (to get a logical view about Edge Node A's performance (e.g., identify potential errors (e.g., performance issues) occurred on Edge Node A while executing a specific workload (e.g., which component was down while executing the workload, what caused that component to went down, etc.); get immediate root cause identification of each component's impact on the execution; etc.)) and (b) the request; (iv) based on (iii), infer dependencies and connectivity among components hosted by Edge Node A (e.g., which components are operating together, which ports are open, etc.); (v) based on (iii) and for each component (of Edge Node A), derive a continuous average resource utilization value with respect to each computing resource; (vi) based on (iii) and for each component (of Edge node A), derive minimum and maximum resource utilization values with respect to each computing resource; (vii) identify (a) health of each component based on average, minimum, and maximum resource utilization values and (b) one or more thresholds that are exceeded; (viii) based on (iii)-(vii), make a determination as to whether Edge Node A is healthy (e.g., Edge Node A's health state/status is healthy or unhealthy); (ix) based on (viii), (a) automatically react and generate alerts if one of the predetermined maximum resource utilization value thresholds is exceeded, (b) initiate, via a GUI of Edge Node A, notification of an administrator about Edge Node A's unhealthy state, and (c) store generated alerts (if any) to the storage (154); (x) based on (viii), determine as to whether a workload (associated with the request) is suitable for Edge Node A (110A) at this point-in-time (said in another way, whether or not Edge Node A (110A) can execute the workload without affecting Edge Node A's ongoing production workloads); (xi) based on (x) and in response to the request (received in (i)), send a response to the scheduler (156) indicating that the workload can be deployed to Edge Node A (110A); (xii) based on (x) and in response to the request (received in (i)), send a response to the scheduler (156) indicating that the workload cannot be deployed to Edge Node A (110A); (xiii) send second metadata associated with the set of policies to an orchestrator (e.g., 125A, FIG. 1.4) (more specifically, to a policy learning module (e.g., 170, FIG. 1.4)); and/or (xiv) store (temporarily or permanently) copies of the metadata and second metadata to the database (e.g., 135, FIG. 1.1) and/or to the storage (154).

As indicated above, the policy engine (150) may act as a central point (in Edge Node A (110A)) for understanding and interpreting a set of unique policies (e.g., defined by one or more users) associated with Edge Node A (110A). Said another way, the policy engine (150) may act as a translator that decodes what each policy means and how that policy should be applied in real-time scenarios (to ensure that to be deployed workloads do not compromise Edge Node A's overall performance).

In one or more embodiments, whenever the scheduler (156) is about to deploy/allocate a workload/task to Edge Node A (110A), the scheduler (156) communicates with the policy engine (150) (to get the policy engine's confirmation about deploying the workload). Based on that, the policy engine (150) cross-references the workload with a corresponding policy (of Edge Node A) to decide whether the workload is suitable for Edge Node A at that specific moment. Said another way, the policy engine (150) may act as a gatekeeper, ensuring that no workload is deployed in violation of that policy.

In one or more embodiments, a policy of the set of policies may, for example (but not limited to): be an operational policy dictating when and how Edge Node A (110A) is allowed to execute a workload; be an energy-saving policy; be a device-specific policy defined by a user for Edge Node A (110A); specify one or more security protocols; specify one or more data handling rules; be a policy that strives for peak efficiency, minimal lag, and the best possible utilization of available computing resources (of Edge Node A (110A)); be a policy that is formed based on a baseline policy (described below) and a workload-specific policy (described below); be a data protection policy (e.g., an affinity-based backup policy); etc.

In one or more embodiments, policies may be classified as (i) baseline policies and (ii) workload-specific policies. A template of a baseline policy may include defining a policy ensuring that resource metrics (e.g., computing resource utilization values) and/or priority configurations (e.g., criticality of workloads) stay within an acceptable range relative to a baseline value. In one or more embodiments, this template may be extended and tailored to match domain specific device (e.g., edge node) requirements, device model (or form factor) specific requirements, and/or resource metric monitoring requirements (e.g., computing resource utilization thresholds that Edge Node A (110A) needs to follow).

In one or more embodiments, a baseline policy may specify (or include), for example (but not limited to): an identifier of the policy (e.g., Baseline Policy T for Edge Node A (110A)), a description of the policy (e.g., “Policy to control execution of scheduled workloads”), a maximum user count (e.g., indicating how many users (at most) may use Edge Node A (110A)), a maximum processing resource utilization threshold (e.g., Edge Node A's CPU utilization value should not exceed 85%, Edge Node A's DPU utilization value should not exceed 85%, etc.), a maximum storage resource utilization threshold, a maximum network/networking resource utilization threshold (e.g., a threshold to keep BW consumption of Edge Node A (110A) under a certain level; if the workload needs BW consumption above the threshold, the workload should not be executed (for not affecting other workloads' ongoing BW consumption); if the BW is full and the workload is a low-priority workload, do not execute the workload now; once the traffic congestion threshold is met, (i) send an alert to the user and (ii) after alerting the user three times, stop execution of the corresponding workload and deem the workload has failed; perform patch update downloads when network BW usage is below the threshold so that, for a better user experience, network congestion is prevented; etc.), an input/output memory management unit configuration, a speed select technology configuration, a network traffic congestion configuration, a period of time specifying when Edge Node A (110A) is allowed to consume maximum power (e.g., Edge Node A is allowed to consume maximum power during the peak time period (09:00-17:00) so that high-priority workloads can be executed during that period, Edge Node A is not allowed to consume maximum power during the non-peak time period (17:01-08:59) so that low-priority workloads can be executed during that period, etc.), a type of the policy (e.g., a high-priority policy, a medium-priority policy, a low-priority policy, etc.), security features associated with the policy (e.g., execute only Federal Information Processing Standard (FIPS) certified workloads, execute only National Institute of Standards and Technology (NIST) compliant workloads, etc.), a memory resource utilization range (e.g., 50-80% memory usage is allowed on Edge Node A (110A) to execute workloads), a networking resource utilization range (e.g., 50-80% BW consumption is allowed on Edge Node A (110A) to execute workloads), types of workloads that are not allowed for execution on Edge Node A (110A) (e.g., workloads that require root privileges), types of workloads that require a valid signature before execution on Edge Node A (110A), etc.

In one or more embodiments, a workload-specific policy may specify (or include), for example (but not limited to): a maximum user count that is supported by Workload A, a user type (e.g., a knowledge worker, a task worker with relatively low-end compute requirements, a high-end user that requires a rich multimedia experience, etc.) that is allowed to execute Workload B, a reserved memory configuration that needs to be satisfied for Workload C, a GPU configuration that needs to be satisfied for Workload R, a memory ballooning configuration that needs to be satisfied for Workload T, a user-defined DPU configuration that needs to be satisfied for Workload Y, a storage space related template that needs to be satisfied for Workload E, a wake on LAN support configuration that needs to be satisfied for Workload U, a user-defined storage mode configuration that needs to be satisfied for Workload P, a practice recommended by a vendor of Workload P (e.g., a single data protection policy should not protect more than 50 assets associated with Workload P per day), etc.

As indicated above, a workload-specific policy (which may know more about a corresponding workload's execution requirements and/or computational needs) may act as an override to a baseline policy in order to allow an execution of a corresponding workload on Edge Node A (110A) without affecting an execution of other workloads (e.g., ongoing workloads) on Edge Node A (110A).

In one or more embodiments, as including intricate details of Edge Node A (110A), the metadata (e.g., device state data) may specify, for example (but not limited to): computing resource utilization data (or key performance metrics) of hardware components and/or software components of Edge Node A, information with respect to a hardware resource set (described above in reference to FIG. 1.1) of Edge Node A, information with respect to real-time CPU usage on Edge Node A, information with respect to real-time vCPU usage on Edge Node A, information with respect to real-time GPU usage on Edge Node A, information with respect to real-time vGPU usage on Edge Node A, information with respect to real-time DPU usage on Edge Node A, information with respect to real-time vDPU usage on Edge Node A, information with respect to real-time memory usage on Edge Node A, information with respect to real-time networking resource usage on Edge Node A, information with respect to real-time storage (or storage space) usage on Edge Node A, information with respect to real-time storage I/O usage on Edge Node A, a type of storage (or storage device) deployed to (or hosted by) Edge Node A, a type of storage controller deployed to (or hosted by) Edge Node A, a type of an OS executed on Edge Node A, an identifier of a user using Edge Node A, a protocol type associated with a port of Edge Node A, IP address details of Edge Node A, information with respect to historical system logs and/or application logs (described above in reference to FIG. 1.1) of Edge Node A, one or more points-in-time and/or one or more periods of time associated with a data recovery event, an identifier of a hardware component of Edge Node A, historical sensor data and its corresponding details, a cumulative history of application upgrade activity records obtained over a prolonged period of time, a cumulative history of user/administrator activity records obtained over a prolonged period of time, an application upgrade sequence, a type of each library hosted by Edge Node A, type and model information of each component of Edge Node A, a version of firmware or other code executing on a component of Edge Node A, information specifying each component's interaction with one another in Edge Node A and/or with another component of a second edge node, etc. In one or more embodiments, the policy engine (150) may store at least a portion of the metadata to the database (e.g., 135, FIG. 1.1).

In one or more embodiments, the metadata may be obtained (or dynamically fetched) as they become available (e.g., with no user manual intervention), or by the policy engine (150) polling a corresponding component(s) of Edge Node A (110A) (by making schedule-driven/periodic API calls to those components without affecting Edge Node A's ongoing production workloads) for newer metadata. Based on receiving the API calls from the policy engine (150), those components may allow the policy engine to obtain the metadata.

In one or more embodiments, the metadata may be obtained (or streamed) continuously as they generated, or they may be obtained in batches, for example, in scenarios where (i) the policy engine (150) receives a metadata analysis request (or a health check request for Edge Node A (110A)), (ii) another component of Edge Node A accumulates the metadata and provides them to the policy engine at fixed time intervals, or (iii) the database (e.g., 135, FIG. 1.1) stores the metadata and notify the policy engine to access the metadata from the database. In one or more embodiments, metadata may be access-protected for a transmission from the policy engine (150) to a corresponding component of the system (e.g., 100, FIG. 1.1), e.g., using encryption.

In one or more embodiments, the second metadata may specify (or include), for example (but not limited to): information with respect to a policy (e.g., an identifier of a user who defined the policy, a feedback/reward regarding the policy (e.g., a status of the policy execution indicating (i) the policy was successfully implemented, (ii) the policy was unsuccessful, (iii) reasons of the policy's failure, etc.) generated by the policy engine (150), etc.), information with respect to a workload that is planned to be deployed to Edge Node A (110A) (e.g., a size of the workload, total execution time of the workload, a class/priority/type of the workload, an identifier of the workload, an identifier of the edge node that executes the workload, computing resource utilization data of the workload, etc.), Policy A needs 65% CPU and 50% memory for its execution, etc.

In one or more embodiments, the policy engine (150) may define feedback regarding a policy in the following way (to ensure that the feedback reflects the objective of optimizing the policy for maximum success in its execution): (i) positive feedback for a successful policy execution on Edge Node A (110A) (e.g., Policy T has a high succession rate when executed on Edge Node A) and (ii) negative feedback for an unsuccessful policy execution on Edge Node A (110A) in relevance to the magnitude of the policy's priority (e.g., Policy R has a low succession rate when executed on Edge Node A because of insufficient memory availability on Edge Node A at this point-in-time (and this needs to be changed via a policy learning module (e.g., 170, FIG. 1.4) by adjusting Policy R so that Policy R will get positive feedback in the next execution)).

One of ordinary skill will appreciate that the policy engine (150) may perform other functionalities without departing from the scope of the embodiments disclosed herein. The policy engine (150) may be implemented using hardware (e.g., a physical device including circuitry), software, or any combination thereof.

In one or more embodiments, upon receiving one or more workloads from an orchestrator (e.g., Orchestrator A (125A), FIG. 1.1), the queue handler (152) may manage and/or reorder (based on each workload's priority) a workload queue stored by the storage (154). The queue handler (152) may manage a workload queue (in both peak and non-peak time periods) so that the scheduler (156) does not get overloaded. For example, when the storage (154) receives ten workloads (to be executed) from the policy learning module (e.g., 170, FIG. 1.4), the scheduler (156) does not need to execute all of them at the same time. With the help of the queue handler (152), the scheduler (156) may execute each workload one by one based on each workload's rank in the workload queue (e.g., a high-priority workload may have the highest rank in the queue and, because of that, this workload may be executed first (after getting the policy engine's (150) confirmation and based on Edge Node A's (110A) health state)).

As yet another example, if the storage (154) receives a high-priority workload and the only available spot/rank in the workload queue is the fourth spot, based on its high-priority and each of other already ranked/listed workloads' priority/criticality, the queue handler (152) may reorder the queue by assigning the just received high-priority workload to the highest rank in the queue.

One of ordinary skill will appreciate that the queue handler (152) may perform other functionalities without departing from the scope of the embodiments disclosed herein. The queue handler (152) may be implemented using hardware, software, or any combination thereof.

In one or more embodiments, the storage (154) may provide long-term, durable, high read/write throughput data storage/protection with near-infinite scale and low-cost. The storage (154) may be a fully managed local storage (e.g., pluggable storage, object storage, block storage, file system storage, data stream storage, Web servers, unstructured storage, etc.) that acts as a shared storage/memory resource that is functional to store unstructured and/or structured data. Further, the storage (154) may also occupy a portion of a physical storage/memory device or, alternatively, may span across multiple physical storage/memory devices.

In one or more embodiments, the storage (154) may be implemented using physical devices that provide data storage services (e.g., storing data and providing copies of previously stored data). The devices that provide data storage services may include hardware devices and/or logical devices. For example, the storage (154) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the storage (154) may include a memory device (e.g., a dual in-line memory device), in which data is stored and from which copies of previously stored data are provided. As yet another example, the storage (154) may include a persistent storage device (e.g., an SSD), in which data is stored and from which copies of previously stored data is provided. As yet another example, the storage (154) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the storage (154) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the storage (154) may store/record unstructured and/or structured data that may include (or specify), for example (but not limited to): a cumulative history of workload deployment requests obtained over a prolonged period of time, historical workloads related to those workload deployment requests, historical metadata (described above) and set of policies (described above) associated with Edge Node A (110A), a cumulative history of Edge Node A's health state (e.g., healthy, unhealthy, etc.), historical feedbacks generated for related policies over a prolonged period of time, one or more workload queues, etc.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored in the storage (154), any of the aforementioned data structures may be stored in different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) (provided by vendors) and/or by the administrators based on, for example, newer (e.g., updated) versions of external information. The unstructured and/or structured data may also be updated when, for example (but not limited to): updated policies are received, newer workloads are received, etc.

While the storage (154) has been illustrated and described as including a limited number and type of data, the storage (154) may store additional, less, and/or different data without departing from the scope of the embodiments disclosed herein. One of ordinary skill will appreciate that the storage (154) may perform other functionalities without departing from the scope of the embodiments disclosed herein.

In one or more embodiments, as being a component (a) to respond real-time device conditions of Edge Node A (110A) and (b) that operates in conjunction with the policy engine (150), the scheduler (156) may include functionality to, e.g.,: (i) send a workload deployment request to the policy engine (150); (ii) receive a response from the policy engine (150) indicating that a workload (related to the workload deployment request sent to the policy engine previously) can be deployed to Edge Node A; (iii) receive a response from the policy engine (150) indicating that a workload (related to the workload deployment request sent to the policy engine previously) cannot be deployed to Edge Node A; and/or (iv) based on (ii), initiate execution of the workload on Edge Node A.

As indicated above, when it is time for the scheduler (156) to deploy/allocate a workload to Edge Node A (110A), the scheduler (156) does not deploy the workload so blindly. Instead, the scheduler (156) first consults with the policy engine (150), which analyzes a rich dataset (e.g., metadata including, at least, Edge Node A's hardware and software specifics, historical performance, and/or user-customized settings that provide insights into Edge Node A's current capabilities and health state) about Edge Node A. Thereafter, based on the rich dataset and corresponding policies (e.g., baseline policies, user-defined policies, workload-specific policies, etc.), the policy engine (150) infers the computational prowess of Edge Node A (110A) and assesses whether Edge Node A has the necessary resources & computational capacity (at that moment) to execute a requested workload. Further, the policy engine (150) analyzes the workload against the policies (including at least rules and conditions) to infer whether or not the workload is suitable for execution on Edge Node A (for example, if Edge Node A's CPU utilization is above the corresponding threshold, the policy engine may not allow execution of this “resource-intensive” workload).

Once the policy engine (150) infers Edge Node A's current state (e.g., healthy, unhealthy, etc.) and the suitability of the workload, the policy engine (150) communicates with the scheduler (156) to allow (or not allow) the scheduler (156) to execute the workload. After the policy engine (150) guarantees that the workload aligns perfectly with the policies (e.g., ensuring that there is no breach of policies/protocols), the policy engine (150) allows the scheduler (156) to execute the workload on Edge Node A (110A).

One of ordinary skill will appreciate that the scheduler (156) may perform other functionalities without departing from the scope of the embodiments disclosed herein. The scheduler (156) may be implemented using hardware, software, or any combination thereof.

In one or more embodiments, the policy engine (150), the queue handler (152), the storage (154), and the scheduler (156) may be utilized in isolation and/or in combination to provide the aforementioned functionalities. These functionalities may be invoked using any communication model including, for example, message passing, state sharing, memory sharing, etc.

Turning now to FIG. 1.3, FIG. 1.3 shows a diagram of the IN (120) in accordance with one or more embodiments disclosed herein. The IN (120) includes an analyzer (160) and an engine (162). The IN (120) may include additional, fewer, and/or different components without departing from the scope of the embodiments disclosed herein. Each component may be operably connected to any of the other component via any combination of wired and/or wireless connections. Each component illustrated in FIG. 1.3 is discussed below.

In one or more embodiments, the analyzer (160) may include functionality to, e.g.,: (i) receive/obtain distributed metadata (e.g., distributed logs) coming from different edge nodes to get a logical view of all logs relevant to process a specific request (e.g., received from an administrator); (ii) use parameters/details available in distributed logs in order to, at least, (a) trace a specific request through a distributed system (e.g., 100, FIG. 1.1), (b) identify potential errors (e.g., performance issues) occurred while processing the specific request (e.g., which application was down while processing the specific request, what caused that application to went down, etc.), (c) trace requests that display high-latency across all applications (e.g., microservices), (d) in conjunction with the engine (162), reduce mean time to troubleshooting performance issues, (e) in conjunction with the engine (162), get immediate root cause identification of every application impact, and (f) improve user experience by re-establishing end-to-end interoperability; (iii) based on (ii), infer dependencies and connectivity among applications executing on the system (e.g., which applications are working together, which ports are open, etc.); (iv) monitor performance (e.g., a health status) of an edge node (e.g., 110A, FIG. 1.1) by obtaining telemetry data (e.g., metadata, computing resource utilization data (or key performance metrics) of hardware and/or software components, etc.) associated with the edge node; (v) based on (iv) and for each component (of the edge node), derive a continuous average resource utilization value with respect to each computing resource; (vi) based on (iv) and for each component (of the edge node), derive minimum and maximum resource utilization values with respect to each computing resource; (vii) identify health of each component based on average, minimum, and maximum resource utilization values; (viii) based on (vii), automatically react and generate alerts if one of the predetermined maximum resource utilization value thresholds is exceeded; (ix) provide identified health of each component (and, indirectly, health of the edge node) and generated alerts (if any) to other entities (e.g., 162) in order to manage the health of the edge node; and/or (x) store monitored resource utilization data and generated alerts (if any) to the database (e.g., 135, FIG. 1.1) to generate a resource utilization map.

In one or more embodiments, while monitoring, the analyzer (160) may need to, for example (but not limited to): inventory one or more hardware and/or software components of an edge node (e.g., 110A, FIG. 1.1); obtain type and model information of each component of an edge node; obtain a version of firmware or other code executing on a component (e.g., a microservice) of an edge node; obtain information specifying each component's interaction with one another in an edge node and/or with another component of a second edge node; etc.

In one or more embodiments, the analyzer (160) may derive minimum and maximum resource utilization values (with respect to each computing resource) as a reference to infer whether a continuous average resource utilization value (with respect to each computing resource) is derived properly. If there is an issue with the derived continuous average resource utilization value, based on the reference, the analyzer (160) may re-derive the continuous average resource utilization value.

In one or more embodiments, the resource utilization map may be implemented using one or more data structures that include information regarding the utilization of computing resources (e.g., a hardware resource, a software resource, a CPU, memory, etc.) of a related edge node (e.g., 110A, FIG. 1.1). The resource utilization map may specify, for example (but not limited to): an identifier of a workload/task/application, an identifier of a computing resource, an identifier of a resource that has been utilized by a workload, etc.

The resource utilization map may specify the resource utilization by any means. For example, the resource utilization map may specify an amount of utilization, resource utilization rates over time, power consumption of applications/microservices while utilized by a user, workloads performed using microservices, etc. The resource utilization map may include other types of information used to quantify the utilization of resources by microservices without departing from the scope of the embodiments disclosed herein.

In one or more embodiments, the resource utilization map may be maintained by, for example, the analyzer (160). The analyzer (160) may add, remove, and/or modify information included in the resource utilization map to cause the information included in the resource utilization map to reflect the current utilization of the computing resources. Data structures of the resource utilization map may be implemented using, for example, lists, tables, unstructured data, structured data, etc. While described as being stored locally, the resource utilization map may be stored remotely and may be distributed across any number of devices without departing from the scope of the embodiments disclosed herein.

Further, the analyzer (160) may include functionality to, e.g.,: (i) obtain/receive data (e.g., metadata (described above in reference to FIG. 1.2) associated with Edge Node A (e.g., 110A, FIG. 1.1), second metadata associated with Edge Node B (e.g., 110B, FIG. 1.1), etc.) from different orchestrators (e.g., from Orchestrator A (e.g., 125A, FIG. 1.4) (more specifically, from the policy learning module (e.g., 170, FIG. 1.4))); (ii) based on (i) and by employing a linear model, a non-linear model, and/or an ML model, analyze and annotate at least a portion of the data to generate annotated data; (iii) based on (ii) and by employing a linear model, a non-linear model, and/or an ML model, clean the annotated data to obtain cleaned annotated data (cleaning the annotated data may include identifying and removing consecutive or useless information from the annotated data); and/or (iv) based on (iii), provide the cleaned annotated data and the remaining portion of the training data (e.g., non-annotated data) to the engine (162).

In one or more embodiments, the analyzer (160) may receive data over a secure tunnel (e.g., a secure/encrypted, point-to-point data transfer path) across (or overlay on) the network (e.g., 130, FIG. 1.1).

In one or more embodiments, as being networking devices, the analyzer (160) and the policy learning module (e.g., 170, FIG. 1.4) may, at least, (i) provide a secure (e.g., an encrypted) tunnel by employing a tunneling protocol (e.g., the generic routing encapsulation (GRE) tunneling protocol, the IP-in-IP tunneling protocol, the secure shell (SSH) tunneling protocol, the point-to-point tunneling protocol, the virtual extensible local area network (VXLAN) protocol, etc.), (ii) set up efficient and secure connections (e.g., a virtual private network (VPN) connection (or a trust relationship), a secure socket layer VPN (SSL VPN) connection, an IP security (IPSec) based VPN connection, a transport layer security VPN (TLS VPN) connection, etc.) between networks, (iii) enable the usage of unsupported network protocols, (iv) manage access to resources between different networks (with more granular control) and track all the operations and network traffic logins, and/oe (v) in some cases, enable users to bypass firewalls (e.g., provide endpoint-to-endpoint connections across a hybrid network without opening firewall rules in an enterprise network).

To this end, for example, the analyzer (160) may include any logic, functions, rules, and/or operations to perform services or functionalities (for communications between the analyzer (160) and the policy learning module (e.g., 170, FIG. 1.4)) such as, for example, SSL VPN connectivity, SSL offloading, switching/load balancing, hypertext transfer protocol secure (HTTPS)-encrypted connections, domain name service (DNS) resolution, and acceleration techniques (e.g., compression (e.g., a context-insensitive compression or context-sensitive compression by employing a delta-type compression model, a lossless compression model, or a lossy compression model), decompression, TCP pooling, TCP multiplexing, TCP buffering, caching, etc.).

As used herein, in networking, “tunneling” is a way for transporting data across a network (e.g., 130, FIG. 1.1) using protocols (standardized set of rules for (i) formatting and processing data, and (ii) enabling computing devices to communicate with one another) that are not supported by that network. In general, a “secure tunnel” refers to a group of microservices/applications that includes, for example (but not limited to): a user interface (UI) server service, an API server service, a controller service, a tunnel connection service, an application mapping service, etc.

Tunneling works by encapsulating packets (packets are small pieces of data that may be re-assembled at their destination into a larger file), in which an “encapsulated packet” is essentially a packet inside another packet. In an encapsulated packet, the header and payload of the first packet goes inside the payload section of the surrounding packet where the original packet itself becomes the payload.

In one or more embodiments, encapsulation may be useful for encrypted network connections (“encryption” refers to the process of scrambling data in such a way that the data may only be unscrambled using a secret encryption key, where the process of undoing the encryption is called “decryption”). If a packet is completely encrypted (including the header), then network routers will not be able to transport the packet to its destination because they do not have the key and cannot see its header. By wrapping the encrypted packet inside another unencrypted packet, the packet may travel across networks like normal.

In one or more embodiments, the analyzer (160) and the policy learning module (e.g., 170, FIG. 1.4) may provide, for example, a TLS VPN connection between the IN (120) and an orchestrator (e.g., Orchestrator A (e.g., 125A, FIG. 1.4)). For example, the policy learning module may request/initiate generation (e.g., establishment) of an end-to-end secure tunnel (e.g., a TLS VPN connection) from Orchestrator A to the IN over the network (e.g., 130, FIG. 1.1). Once the secure tunnel is generated: (i) the policy learning module may encrypt one or more data packets (associated with data) and transmit them to the analyzer via the secure tunnel, (ii) after receiving the data packets, the analyzer may decrypt the data packets and send those packets to the engine (162) for further processing, and (iii) the analyzer and policy learning module may then effectively terminate the secure tunnel by managing the behavior of the secure tunnel.

In one or more embodiments, each of the analyzer (160) and the policy learning module (e.g., 170, FIG. 1.4) may include an encryption/decryption engine (not shown) providing logic, business rules, functions, or operations for handling the processing of any security related protocol (e.g., the SSL protocol, the TLS protocol, etc.) or any function related thereto. For example, the encryption/decryption engine may encrypt or decrypt data packets (based on executable instructions) communicated over the network (e.g., 130, FIG. 1.1). The encryption/decryption engine may also establish secure tunnel connections on behalf of, for example, the analyzer.

In one or more embodiments, each of the analyzer (160) and the policy learning module (e.g., 170, FIG. 1.4) may also include a network optimization engine (not shown) for optimizing, accelerating, or otherwise improving the performance, operation, or quality of any network traffic (or communications) traversing of, for example, the analyzer.

One of ordinary skill will appreciate that the analyzer (160) may perform other functionalities without departing from the scope of the embodiments disclosed herein. The analyzer (160) may be implemented using hardware, software, or any combination thereof.

In one or more embodiments, the engine (162) may include functionality to, e.g.,: (i) upon receiving/obtaining a dataset (including the cleaned annotated data and non-annotated data) from the analyzer (160), and by employing a linear model, a non-linear model, and/or an ML model, split the dataset into training data and testing data (e.g., the engine may split the dataset as 60% training data and 40% testing data); (ii) based on (i) and a target parameter (e.g., generating a device-specific policy that will have the highest succession rate when executed), generate a reinforcement learning model (RLM) (e.g., a proximal policy optimization (PPO) model, a trust region policy optimization (TRPO) model, a deep deterministic policy gradient (DDPG) model, etc.) by training (and/or fine-tuning) a suitable model (e.g., an ML model) using the training data; (iii) evaluate the accuracy of the RLM using the testing data; (iv) after confirming the accuracy of the RLM, deploy the RLM to a related policy learning module (e.g., 170, FIG. 1.4); (v) based on (iv) and using a GUI of the IN (120), initiate notification of an administrator of the IN (120) about deployment of the RLM (to the module); (vi) perform one or more jobs (e.g., a data protection job, a data restoration job, a log retention job, a policy related job, etc.); and/or (vii) based on (vi), provide details of a job (e.g., a type of a job (such as a non-parallel processing job, a parallel processing job, an analytics job, etc.), a completion timestamp encoding a date and/or time reflective of a successful completion of a job, a time duration reflecting the length of time expended for executing and completing a job, a status of a job (e.g., how many jobs are still active, how many jobs are completed, etc.), a number of errors encountered while handling a job, information regarding an administrator (e.g., a high-priority trusted administrator, a low-priority trusted administrator, etc.) related to an analytics job, etc.) to the database (e.g., 135, FIG. 1.1) for storage.

In one or more embodiments, before generating the RLM, the engine (162) may obtain one or more model parameters (from the database (e.g., 135, FIG. 1.1)) that provide instructions on how to obtain the RLM. The model parameters may also specify, including (but not limited to): one or more ML models (e.g., a random forest regression model, a neural network model, a logistic regression model, the K-nearest neighbor model, the extreme gradient boosting (XGBoost model), a Naïve Bayes classification model, a support vector machines (SVM) model, etc.), details regarding different environments (e.g., indoor environments, outdoor environments, etc.) that the RLM may need to operate, different feedbacks/rewards that may be obtained by the RLM, etc.

In one or more embodiments, the RLM may be adapted to execute specific determinations described herein with reference to any component of the system (e.g., 100, FIG. 1.1) and processing operations executed thereby.

In one or more embodiments, as the RLM is a learning model, the RLM may be updated periodically as there are improvements in the underlying models, or accuracy of the model may be improved over time through iterations of re-training (and/or fine-tuning), receipt of user feedbacks, etc. Re-training (and/or fine-tuning) the RLM may include application of a training algorithm. As an example, a decision tree (e.g., a Gradient Boosting Decision Tree) may be used to re-train the RLM. In doing so, one or more types of decision tree algorithms may be applied for generating any number of decision trees to fine-tune the RLM. In one or more embodiments, re-training of the RLM may further include generating an ML model that is tuned to reflect specific metrics for accuracy, precision, and/or recall before the trained ML model is exposed for real-time (or near real-time) usage.

In one or more embodiments, an RLM is selected as a model that will be deployed to (and employed by) a corresponding policy learning module (e.g., 170, FIG. 1.4) because: (i) training data may be scarce and/or unavailable (as workloads' resource consumption and computing resource capabilities of an edge node may differ on a case-to-case basis), and (ii) policies may be executed in various different environments (e.g., Policy A may be executed on a heterogeneous and ever-changing environment).

Further, the engine (162) may include functionality to, e.g.,: (i) in conjunction with the analyzer (160), provide a useful ML-based framework to the administrator to at least assist the administrator for accurately detecting one or more anomalies in, for example, system logs (of an edge node) and to increase the administrator's performance (in terms of taking actions to (a) remediate hardware/software component related issues (occurred in the edge node) faster and/or (b) prevent any future hardware/software component related issues that may occur on the edge node); (ii) in conjunction with the analyzer (160), automate at least some of the “issue detection” tasks/duties assigned to the administrator for a better administrator experience; and/or (iii) in conjunction with the analyzer (160), analyze metadata (e.g., system logs, application logs, etc.) obtained from an edge node (a) to identify health (or health information) of each component of the edge node, (b) to tag/label each component as “healthy” or “unhealthy” for troubleshooting and optimization purposes, (c) to infer an overall health status of the edge node, and (d) to generate a device state path for the edge node (e.g., from a healthy device state to an unhealthy device state) (which may be useful for the administrator to infer how a hardware component failure has occurred (in the edge node) and to identify the various states that the edge node was in).

In one or more embodiments, the engine (162) may generate a device state chain (of an edge node (e.g., 110A, FIG. 1.1)) using a device state path (which corresponds to device states up to a current device state), a current device state, and a next device state of the edge node. As indicated, while generating the device state chain, not just the previous device state is considered, but the whole device state path is considered. For example, the engine (162) may generate a device state chain as A→B (where B is the current device state of an edge node) and B→C (where A represents “fan failure”, B represents “overheating of CPU”, and C represents “CPU failure”). In this example, the engine (162) (i) may calculate the probability of “A→B” in the device state chain as 0.2 and (ii) may calculate the probability of “B→C” in the device state chain as 0.3, where the probability of the device state chain “A→B→C” may be calculated as 0.06.

As discussed above, the engine (162) may infer a current device state of a device (e.g., an edge node) based on metadata (obtained from the edge node), in which the current device state may indicate a device state where a hardware component failure was reported. In one or more embodiments, the engine (162) may include a list of device states (associated with the edge node) where the edge node transitioned and, among the list of device states, a next device state may be the device state that has the highest probability to become the next device state.

One of ordinary skill will appreciate that the engine (162) may perform other functionalities without departing from the scope of the embodiments disclosed herein. The engine (162) may be implemented using hardware, software, or any combination thereof.

In one or more embodiments, the analyzer (160) and the engine (162) may be utilized in isolation and/or in combination to provide the aforementioned functionalities. These functionalities may be invoked using any communication model including, for example, message passing, state sharing, memory sharing, etc.

Turning now to FIG. 1.4, FIG. 1.4 shows a diagram of an orchestrator (e.g., Orchestrator A (125A)) in accordance with one or more embodiments disclosed herein. Orchestrator A (125A) includes a policy learning module (170), storage (172), and a visualizer (174). Orchestrator A (125A) may include additional, fewer, and/or different components without departing from the scope of the embodiments disclosed herein. Each component may be operably connected to any of the other component via any combination of wired and/or wireless connections. Each component illustrated in FIG. 1.4 is discussed below.

In one or more embodiments, Orchestrator A (125A) may have relatively more hardware and/or software resources when compared to, for example, Edge Node A (e.g., 110A, FIG. 1.2).

In one or more embodiments, the policy learning module (170) may include functionality to, e.g.,: (i) post-workload execution (by a related scheduler (e.g., 156, FIG. 1.2)), obtain/receive “real-time” second metadata (described above in reference to FIG. 1.2) from the storage (172) (or indirectly from a related policy engine (e.g., 150, FIG. 1.2)); (ii) by employing a set of linear, non-linear, and/or ML models, analyze the second metadata to infer a type of feedback generated by the policy engine; (iii) based on (ii), make a determination as to whether the feedback is positive feedback (indicating that the policy execution was successful); (iv) based on (iii), notify the policy engine to indicate that the related policy (executing on the corresponding edge node) is still enforceable; (v) based on (iii) by employing the RLM (which include one or more deep neural networks and is deployed to the policy learning module (170) by the engine (e.g., 162, FIG. 1.3)), modify the policy (e.g., by adjusting some parameters of the policy) to generate a modified policy based on a probability distribution over candidate policies (in order to (a) ensure the highest succession rate of policy execution on the edge node and/or (b) suggest the best policy that can be applied to edge nodes sharing the same node family); and/or (vi) provide the modified policy to storage (e.g., 154, FIG. 1.2) of the edge node (e.g., 110A, FIG. 1.2) as an update.

One of ordinary skill will appreciate that the policy learning module (170) may perform other functionalities without departing from the scope of the embodiments disclosed herein. The policy learning module (170) may be implemented using hardware, software, or any combination thereof.

In one or more embodiments, the storage (172) may provide long-term, durable, high read/write throughput data storage/protection with near-infinite scale and low-cost. The storage (172) may be a fully managed local storage (e.g., pluggable storage, object storage, block storage, file system storage, data stream storage, Web servers, unstructured storage, etc.) that acts as a shared storage/memory resource that is functional to store unstructured and/or structured data. Further, the storage (172) may also occupy a portion of a physical storage/memory device or, alternatively, may span across multiple physical storage/memory devices.

In one or more embodiments, the storage (172) may be implemented using physical devices that provide data storage services (e.g., storing data and providing copies of previously stored data). The devices that provide data storage services may include hardware devices and/or logical devices. For example, the storage (172) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the storage (172) may include a memory device (e.g., a dual in-line memory device), in which data is stored and from which copies of previously stored data are provided. As yet another example, the storage (172) may include a persistent storage device (e.g., an SSD), in which data is stored and from which copies of previously stored data is provided. As yet another example, the storage (172) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the storage (172) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the storage (172) may store/record unstructured and/or structured data that may include (or specify), for example (but not limited to): a cumulative history of modified policy deployments over a prolonged period of time, second metadata received from a corresponding policy engine (e.g., 150, FIG. 1.2), a cumulative history of inferred feedbacks over a prolonged period of time, etc.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored in the storage (172), any of the aforementioned data structures may be stored in different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) (provided by vendors) and/or by the administrators based on, for example, newer (e.g., updated) versions of external information. The unstructured and/or structured data may also be updated when, for example (but not limited to): modified policies are generated, newer feedbacks are inferred, etc.

While the storage (172) has been illustrated and described as including a limited number and type of data, the storage (172) may store additional, less, and/or different data without departing from the scope of the embodiments disclosed herein. One of ordinary skill will appreciate that the storage (172) may perform other functionalities without departing from the scope of the embodiments disclosed herein.

In one or more embodiments, the visualizer (174) may initiate, for example, displaying of (i) identified health (or device status) of a corresponding edge node (e.g., 110A, FIG. 1.2), (ii) a holistic user profile of a user of the edge node, (iii) scheduled workloads on the edge node, (iii) alerts/notifications generated (e.g., when resource utilization thresholds are exceeded) for the edge node, (iv) a holistic summary of all edge nodes (e.g., online edge nodes, offline edge nodes, healthy edge nodes, unhealthy edge nodes, etc.), (v) real-time device health indicators (e.g., battery status, CPU usage, DPU usage, memory usage, network connectivity, etc.) of a corresponding edge node, and/or (vi) a workload queue (of a related edge node) indicating scheduled, pending, or cancelled workloads to an administrator via the visualizer (174) (e.g., via a GUI, an API, a programmatic interface, and/or a communication channel of the visualizer) to indicate an overall health status of each edge node.

In one or more embodiments, for example, (i) each data item (e.g., identified health of an edge node, a generated alert, etc.) may be displayed (e.g., highlighted, visually indicated, etc.) with a different color (e.g., red color tones may represent a negative overall health status of an edge node, green color tones may represent a positive overall health status of an edge node, etc.), and (ii) one or more useful insights/recommendations with respect to the overall health status of an edge node may be displayed in a separate window(s) on the visualizer (174) to assist the administrator while managing the overall health status of the edge node (e.g., for a better administrator experience, to help the administrator with respect to understanding the benefits and trade-offs of selecting different troubleshooting options, etc.).

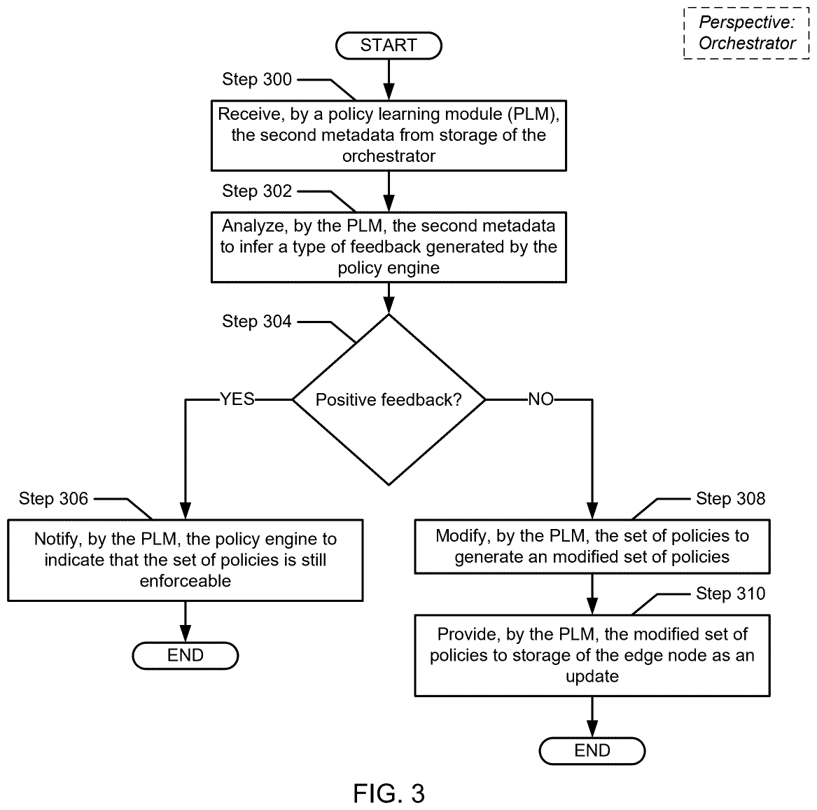

Further, the visualizer (174) may include functionality to, e.g.,: (i) obtain (or receive) data (e.g., any type and/or quantity of input) from any source (e.g., a user via an edge node (e.g., 110A, FIG. 1.2), the policy learning module (170), etc.) (and, if necessary, aggregate the data); (ii) based on (i) and by employing a set of linear, non-linear, and/or ML models, analyze, for example, a query to derive additional data; (iii) encompass hardware and/or software components and functionalities provided by Orchestrator A (125A) to operate as a service over the network (e.g., 130, FIG. 1.1) so that the visualizer (174) may be used externally; (iv) employ a set of subroutine definitions, protocols, and/or hardware/software components for enabling/facilitating communications between, for example, the policy learning module (170) and external entities (e.g., edge nodes, administrators, etc.); (v) by generating one or more visual elements, allow an administrator to, at least, interact with a user of a corresponding edge node; (vi) receive a customer/user profile of a customer and display the customer profile to an administrator (e.g., for monitoring and/or performance evaluation); (vii) concurrently display one or more separate windows, for example, on its GUI; and/or (viii) generate visualizations of the method illustrated in FIG. 3.

One of ordinary skill will appreciate that the visualizer (174) may perform other functionalities without departing from the scope of the embodiments disclosed herein. The visualizer (174) may be implemented using hardware, software, or any combination thereof.

In one or more embodiments, the policy learning module (170), the storage (172), and the visualizer (174) may be utilized in isolation and/or in combination to provide the aforementioned functionalities. These functionalities may be invoked using any communication model including, for example, message passing, state sharing, memory sharing, etc.

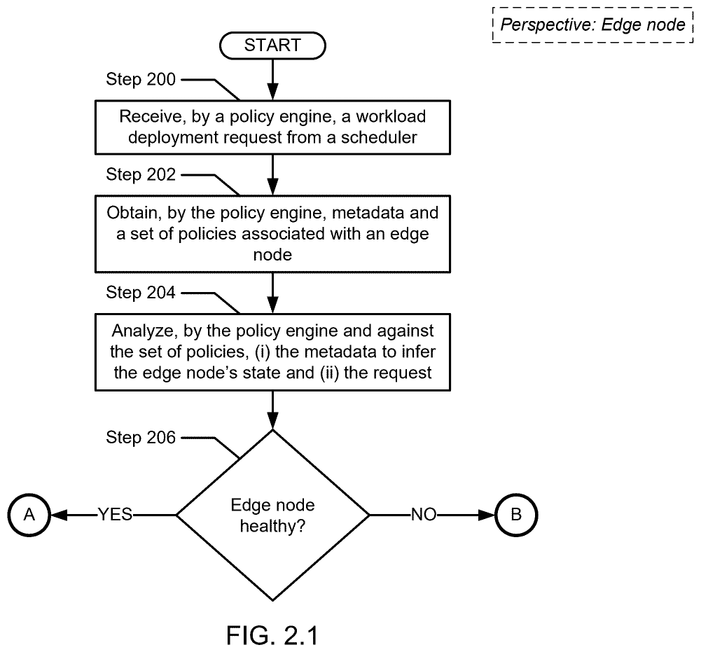

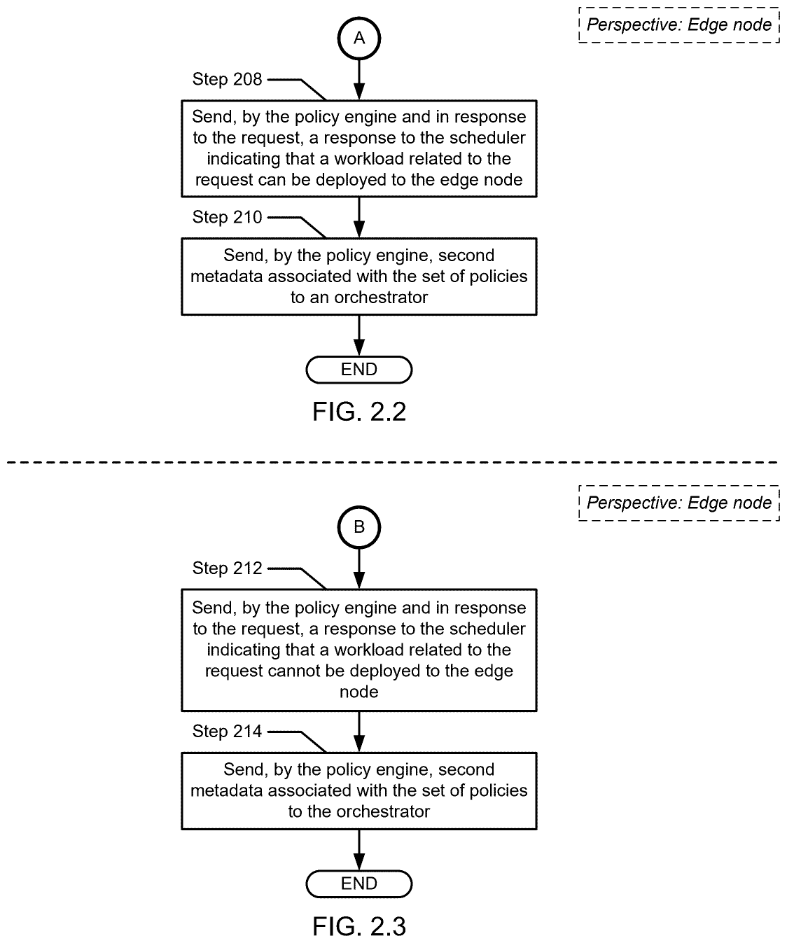

FIGS. 2.1-2.3 show a method for managing a workload deployment on an edge node (e.g., 110A, FIG. 1.2) in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 2.1, the method shown in FIG. 2.1 may be executed by, for example, the above-discussed policy engine (e.g., 150, FIG. 1.2). Other components of the system (100) illustrated in FIG. 1 may also execute all or part of the method shown in FIG. 2.1 without departing from the scope of the embodiments disclosed herein.

In Step 200, the policy engine receives a workload deployment request from a requesting entity (e.g., an administrator of the edge node, an administrator terminal, a scheduler (e.g., 156, FIG. 1.2), etc.) that wants to deploy a workload to the edge node.

In Step 202, in response to receiving the request, as part of that request, and/or in any other manner (e.g., before initiating any computation with respect to the request), the policy engine obtains real-time metadata (from each component of the edge node) and a set of policies (associated with the edge node) from storage (e.g., 154, FIG. 1.2) of the edge node. In one or more embodiments, the metadata may be obtained continuously or at regular intervals (e.g., every two seconds) (without affecting production workloads of the edge node). Further, the metadata may be access-protected for the transmission from, for example, a corresponding component (of the edge node) to the policy engine, e.g., using encryption.

In one or more embodiments, the metadata may be obtained as it becomes available or by the policy engine polling each component (via one or more API calls) for newer information. For example, based on receiving an API call from the policy engine, the storage of the edge node may allow the policy engine to obtain newer information. Details of metadata are described above in reference to FIG. 1.2.

In Step 204, against the set of policies (e.g., baseline policies, user-defined policies, workload-specific policies, etc.) and by employing a set of linear, non-linear, and/or ML models, the policy engine analyzes (i) the metadata to infer a current state (or health status) of the edge node (or the edge node's state such as healthy, unhealthy, etc.) and (ii) the request (received in Step 200) to ensure compatibility of the workload.

In Step 206, based on Step 204, the policy engine makes a determination (in real-time or near real-time) as to whether (i) the current state of the edge node is healthy (e.g., the edge node is operational, at least the edge node's processing resource utilization does not exceed a maximum processing resource utilization threshold, etc.) and (ii) the workload is suitable for the edge node at this moment in time (e.g., as to whether the workload can be executed on the edge node now). Accordingly, in one or more embodiments, if the result of the determination is YES (e.g., the current state of the edge node is healthy and the workload does not violate any policy of the set of policies), the method proceeds to Step 208 of FIG. 2.2. If the result of the determination is NO (e.g., e.g., the network's BW is currently full and the workload is a low-priority workload, the current state of the edge node is unhealthy, etc.), the method alternatively proceeds to Step 212 of FIG. 2.3.

Turning now to FIG. 2.2, the method shown in FIG. 2.2 may be executed by, for example, the above-discussed policy engine. Other components of the system (100) illustrated in FIG. 1 may also execute all or part of the method shown in FIG. 2.2 without departing from the scope of the embodiments disclosed herein.

In Step 208, as a result of the determination in Step 206 of FIG. 2.1 being YES and in response to the request (received in Step 200 of FIG. 2.1), the policy engine sends a response to the scheduler indicating that the scheduler is allowed to deploy/execute the workload (related to the request) to/on the edge node. In Step 210, the policy engine sends second metadata (e.g., policy-centric telemetry data) associated with the set of policies to an orchestrator (more specifically, to a policy learning module (e.g., 170, FIG. 1.4) of the orchestrator) for, for example, the training of the RLM. Details of second metadata are described above in reference to FIG. 1.2. In one or more embodiments, the method may end following Step 210.

Turning now to FIG. 2.3, the method shown in FIG. 2.3 may be executed by, for example, the above-discussed policy engine. Other components of the system (100) illustrated in FIG. 1 may also execute all or part of the method shown in FIG. 2.3 without departing from the scope of the embodiments disclosed herein.

In Step 212, as a result of the determination in Step 206 of FIG. 2.1 being NO and in response to the request (received in Step 200 of FIG. 2.1), the policy engine sends a response to the scheduler indicating that the scheduler is not allowed to deploy/execute the workload (related to the request) to/on the edge node. In this manner, for example, operational costs (related to the edge node) may be reduced by ensuring that this “resource-intensive” workload is performed when computing resources of the edge node are available (e.g., not during peak usage time(s) of the resources). In one or more embodiments, as a result of the determination in Step 206 of FIG. 2.1 being NO, the policy engine may initiate notification of an administrator (via a GUI of the edge node) about the edge node's unhealthy state.

In Step 214, the policy engine sends second metadata (e.g., policy-centric telemetry data) associated with the set of policies to the orchestrator (more specifically, to the policy learning module of the orchestrator). In one or more embodiments, the policy engine may send the second metadata to receive an updated policy, in which the updated policy may be received by the edge node (at a later point-in-time) as an update (see Step 310 of FIG. 3) to overcome a low succession rate of a current policy (of the set of policies). In one or more embodiments, the method may end following Step 214.

FIG. 3 shows a method for managing a policy executing on the edge node in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 3, the method shown in FIG. 3 may be executed by, for example, the above-discussed policy learning module. Other components of the system (100) illustrated in FIG. 1 may also execute all or part of the method shown in FIG. 3 without departing from the scope of the embodiments disclosed herein.

In Step 300, the policy learning module receives/obtains the second metadata (specifying at least information with respect to the policy and information with respect to the workload that is planned to be deployed to the edge node) from storage of the orchestrator (e.g., 172, FIG. 1.4) (which is provided to the storage by the policy engine (see e.g., Step 224 of FIG. 2.3)). In Step 302, by employing a set of linear, non-linear, and/or ML models, the policy learning module analyzes the second metadata to infer a type of feedback generated by the policy engine.

In Step 304, based on Step 302, the policy learning module makes a determination (in real-time or near real-time) as to whether the feedback is positive feedback (indicating that the policy execution was successful). Accordingly, in one or more embodiments, if the result of the determination is YES, the method proceeds to Step 306. If the result of the determination is NO (indicating that the policy execution was not successful), the method alternatively proceeds to Step 308.

In Step 306, as a result of the determination in Step 304 being YES (e.g., the feedback is positive feedback), the policy learning module notifies the policy engine to indicate that the policy (executing on the edge node) is still enforceable. In one or more embodiments, the method may end following Step 306.

In Step 308, as a result of the determination in Step 304 being NO (e.g., the feedback is negative feedback) and by employing the RLM (discussed above in reference to FIG. 1.3), the policy learning module modifies the policy (e.g., by adjusting some parameters of the policy) to generate a modified policy (which is expected to have a high succession rate when executed on the edge node). In Step 310, the policy learning module provides the modified policy to the storage of the edge node as an update. In one or more embodiments, the method may end following Step 310.

Turning now to FIG. 4, FIG. 4 shows a diagram of a computing device in accordance with one or more embodiments disclosed herein.

In one or more embodiments disclosed herein, the computing device (400) may include one or more computer processors (402), non-persistent storage (404) (e.g., volatile memory, such as RAM, cache memory), persistent storage (406) (e.g., a non-transitory computer readable medium, a hard disk, an optical drive such as a CD drive or a DVD drive, a Flash memory, etc.), a communication interface (412) (e.g., Bluetooth interface, infrared interface, network interface, optical interface, etc.), an input device(s) (410), an output device(s) (408), and numerous other elements (not shown) and functionalities. Each of these components is described below.

In one or more embodiments, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (e.g., a LAN, a WAN, Internet, mobile network, etc.) and/or to another device, such as another computing device.

In one or more embodiments, the computing device (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing a workload deployment, the method comprising:
receiving a workload deployment request from a scheduler;
obtaining metadata and a policy associated with an edge node (EN);
analyzing, against the policy, the request and the metadata to infer a current state (CS) of the EN;
making, based on the analyzing, a determination that the CS of the EN is healthy and a workload associated with the request is suitable for the EN;
sending, based on the determination, a response to the scheduler to indicate that the scheduler is allowed to deploy the workload to the EN; and
sending, after sending the response, second metadata associated with the policy to an orchestrator, wherein the EN and the orchestrator are operably connected to each other over a combination of wired and wireless connections.

2. The method of claim 1, wherein the policy dictates when and how the EN is allowed to execute the workload.

3. The method of claim 1,
wherein the policy is a device-specific policy defined by a user for the EN,
wherein the policy is formed based on a baseline policy and a workload-specific policy, and
wherein the workload-specific policy acts as an override to the baseline policy in order to allow an execution of the workload on the EN without affecting an execution of a second workload on the EN.

4. The method of claim 3, wherein the baseline policy specifies at least one selected from a group consisting of a maximum user count, a maximum processing resource utilization threshold, a maximum storage resource utilization threshold, a maximum network resource utilization threshold, an input/output memory management unit configuration, a speed select technology configuration, a network traffic congestion configuration, and a period of time specifying when the EN is allowed to consume maximum power.

5. The method of claim 3, wherein the workload-specific policy specifies at least one selected from a group consisting of a maximum user count that is supported by the workload, a reserved memory configuration that needs to be satisfied for the workload, a graphics processing unit (GPU) configuration that needs to be satisfied for the workload, a memory ballooning configuration that needs to be satisfied for the workload, and a data processing unit (DPU) configuration that needs to be satisfied for the workload.

6. The method of claim 1, wherein the metadata specifies at least one selected from a group consisting of information with respect to a hardware resource set of the EN, information with respect to real-time central processing unit (CPU) usage on the EN, information with respect to real-time memory usage on the EN, a type of a storage device deployed to the EN, and a type of an operating system executed on the EN.

7. The method of claim 1, wherein the second metadata is sent to the orchestrator to receive an updated policy, wherein the updated policy is sent to the EN as an update to overcome a low succession rate of the policy.

8. The method of claim 1, wherein being healthy indicates that at least the EN's processing resource utilization does not exceed a maximum processing resource utilization threshold.

9. A method for managing a workload deployment, the method comprising:
receiving a workload deployment request from a scheduler;
obtaining metadata and a policy associated with an edge node (EN);
analyzing, against the policy, the request and the metadata to infer a current state (CS) of the EN;
making, based on the analyzing, a determination that the CS of the EN is healthy and a workload associated with the request is not suitable for the EN;
sending, based on the determination, a response to the scheduler to indicate that the scheduler is not allowed to deploy the workload to the EN; and
sending, after sending the response, second metadata associated with the policy to an orchestrator, wherein the EN and the orchestrator are operably connected to each other over a combination of wired and wireless connections.

10. The method of claim 9, wherein the policy dictates when and how the EN is allowed to execute the workload.

11. The method of claim 9,
wherein the policy is a device-specific policy defined by a user for the EN,
wherein the policy is formed based on a baseline policy and a workload-specific policy, and
wherein the workload-specific policy acts as an override to the baseline policy in order to allow an execution of the workload on the EN without affecting an execution of a second workload on the EN.

12. The method of claim 11, wherein the baseline policy specifies at least one selected from a group consisting of a maximum user count, a maximum processing resource utilization threshold, a maximum storage resource utilization threshold, a maximum network resource utilization threshold, an input/output memory management unit configuration, a speed select technology configuration, a network traffic congestion configuration, and a period of time specifying when the EN is allowed to consume maximum power.

13. The method of claim 11, wherein the workload-specific policy specifies at least one selected from a group consisting of a maximum user count that is supported by the workload, a reserved memory configuration that needs to be satisfied for the workload, a graphics processing unit (GPU) configuration that needs to be satisfied for the workload, a memory ballooning configuration that needs to be satisfied for the workload, and a data processing unit (DPU) configuration that needs to be satisfied for the workload.

14. The method of claim 9, wherein the metadata specifies at least one selected from a group consisting of information with respect to a hardware resource set of the EN, information with respect to real-time central processing unit (CPU) usage on the EN, information with respect to real-time memory usage on the EN, a type of a storage device deployed to the EN, and a type of an operating system executed on the EN.

15. The method of claim 9, wherein the second metadata is sent to the orchestrator to receive an updated policy, wherein the updated policy is sent to the EN as an update to overcome a low succession rate of the policy.

16. The method of claim 9, wherein being healthy indicates that at least the EN's processing resource utilization does not exceed a maximum processing resource utilization threshold.

17. A method for managing a policy executing on an edge node (EN), the method comprising:
receiving metadata, wherein the metadata specifies at least information with respect to the policy and information with respect to a workload that is planned to be deployed to the EN;
analyzing the metadata to infer a type of a feedback generated by a policy engine of the EN;
making, based on the analyzing, a determination that the type of the feedback is negative;
modifying, based on the determination, the policy to generate a modified policy; and
providing the modified policy to the EN as an update.

18. The method of claim 17,
wherein the modifying is performed using a reinforcement learning model (RLM),
wherein the RLM is trained by an engine based on training data obtained from a policy learning module (PLM), wherein the engine and the PLM are operably connected to each other over a combination of wired and wireless connections,
wherein the RLM modifies the policy by changing a parameter of the policy, and
wherein, by changing the parameter, the RLM generates the modified policy and make the modified policy to have a high succession rate when executed on the EN.

19. The method of claim 17, wherein the determination indicates that the feedback is a negative feedback, wherein the negative feedback indicates that the policy has not been successfully executed on the EN because of insufficient memory availability on the EN.

20. The method of claim 17, wherein the policy dictates when and how the EN is allowed to execute the workload.
